(19) United States
(12) Patent Application Publication
(10) Pub. No.: US 2003/0151871 A1
(43) Pub. Date: Aug. 14, 2003

(54) Reception of digitally coded protection signals in a remote tripping device

(75) Inventor: Hermann Schnyder, Wadenswil (CH)

Correspondence Address: BURNS, DOANE, SWECKER & MATHIS, L.L.P., P.O. Box 1404, Alexandria, VA, 22313-1404, US

(73) Assignee: ABB Schweiz AG, Baden (CH)

(21) Appl. No.: 10/359,090

(22) Filed: Feb. 6, 2003

(30) Foreign Application Priority Data
Feb. 12, 2002 (EP) 02405104.7

(51) Int. Cl. H02H 3/20

(52) U.S. Cl. 361/91.1

(57) ABSTRACT

In a remote tripping device and in a method for reception of digitally coded protection signals in a remote tripping device, a sequence of digital code words is received on a transmission channel, and a protection signal is regarded as having been received when a code which corresponds to this protection signal has been detected in this sequence a total of n times within a time window of predetermined length, wherein the number n is determined on the basis of an estimate of a measure at any given time of a disturbance on the transmission channel.

### DESCRIPTION

1. Technical Field

The invention relates to the field of protection technology for high-voltage and medium-voltage networks. It relates to a method for reception of digitally coded protection signals in a remote tripping device, and to a remote tripping device as claimed in the precharacterizing clause of patent claims 1 and 6.

1. Prior Art

Remote tripping devices or protection signal transmission devices are used for transmitting protection or switching commands for distance protection in electrical high-voltage and medium-voltage networks and systems. Protection commands result, for example, in a circuit breaker being opened directly or indirectly and, in consequence, in electrical disconnection of a part of the network or of the system. Conversely, other protection commands result in opening of a circuit breaker being prevented. Protection commands must be transmitted, for example, from one section of a high-voltage line to another. To do this, a transmitter in a remote tripping device produces digitally coded signals in accordance with the protection commands, which digitally coded signals are transmitted via a signal link which is formed by a digital communication medium. A receiver in another remote tripping device detects the transmitted signals and determines the corresponding values of the protection commands.

Depending on the nature of the protection command, different requirements are in this case placed on the signal transmission and detection, and these can be characterized by the transmission time and bit rate or bandwidth, and by the following parameters:

Puc Safety and/or security value, that is to say the probability that a command is received falsely, even though it has not actually been transmitted. A low Puc value corresponds to high transmission safety and/or security.

Pmc Reliability value, that is to say the probability that a command which has been transmitted is not received. A low Pmc value corresponds to high transmission reliability.

In general, it can be said that, as the disturbance power increases, that is to say as the bit error rate (BER) of the transmission channel increases,

the safety and/or security first of all decreases and then increases once again, that is to say the safety and/or security value Puc firstly increases and then decreases again, and

the reliability decreases continuously, that is to say the reliability value Pmc increases continuously.

Disturbances in the transmission caused by bit errors must not simulate any commands in a rest situation and, on the other hand, when a command occurs, must not unacceptably delay a real command, or even lead to it being lost. High safety and/or security and high reliability with a short transmission time and a narrow bandwidth at the same time are contradictory requirements. However, one variable can always be improved at the expense of the other characteristics. The compromise is governed by the application. Thus, for example, indirectly tripping protection systems require short transmission times with high reliability and reasonable safety and/or security. Applications with direct switch tripping, on the other hand, demand very high safety and/or security and reliability, with the transmission time requirements being less stringent.

An individual protection command or a combination of a number of protection commands is or are represented or coded by means of protection signals. By way of example, a first protection signal represents a first protection command, and a second protection signal represents the first protection command in conjunction with a second protection command. In order to satisfy the various requirements, the protection signals are digitally coded and are transmitted redundantly. This improves the safety and/or security and the reliability. Redundancy is introduced, for example, by using a digital code with different code words with a Hamming distance and/or by repeating data frames which contain the code words.

In order to make it possible to decide that a protection signal, and hence one or more protection commands, have been received with a predetermined safety and/or security level, the receiver must detect a total of n correct code words within a time window of predetermined length. This is described, for example, in “Dimat Digital Teleprotection System Type TPD-1, General Description Rev. 6 October '98”, sections 3.1. and 3.2. The number n for a required safety and/or security value Puc depends on the level of any disturbance on the transmission channel. If a maximum disturbance level is assumed, a maximum number nₘₐₓ of correctly detected code words are required in order to guarantee that the required Puc value is achieved. In normal operating conditions, the disturbance in the transmission channel is, however, very much less than in the worst case, and less than nₘₐₓ correct code words would thus be sufficient. At the moment, receivers always wait for nₘₐₓ correct code words in order to make it possible to always guarantee the required safety and/or security level.

### DESCRIPTION OF THE INVENTION

The object of the invention is therefore to provide a method for reception of digitally coded protection signals in a remote tripping device, as well as a remote tripping device of the type mentioned initially, which allow faster detection of protection signals.

This object is achieved by a method for reception of digitally coded protection signals in a remote tripping device and by a remote tripping device having the features of patent claims 1 and 6.

In the method according to the invention for reception of digitally coded protection signals in a remote tripping device, a sequence of digital code words is received on a transmission channel, and a protection signal is regarded as having been received when a code which corresponds to this protection signal has been detected in this sequence a total of n times within a time window of predetermined length, wherein the number n is determined on the basis of an estimate of a measure at any given time of a disturbance on the transmission channel.

In consequence, it is possible to reduce the number n when there is little disturbance on the transmission channel and hence to shorten the transmission time for the protection signal while, nevertheless, complying with a predetermined safety and/or security requirement for the transmission at the same time.

In one preferred embodiment of the invention, the measure of the disturbance on the transmission channel is a bit error rate on the transmission channel, and the number n is determined on the basis of the bit error rate and a requirement for the safety and/or security level of the transmission. In a further preferred embodiment of the invention, the bit error rate is determined on the basis of the received sequence of code words.

The remote tripping device according to the invention has a means for reception of a sequence of digital code words on a transmission channel, at least one detector for detection of a code which corresponds to a protection signal, and at least one means for signaling that a protection signal is regarded as having been received if a code which corresponds to the protection signal is detected a total of n times in this sequence within a time window of predetermined length, wherein the number n can be determined on the basis of an estimate of a measure at any given time of a disturbance on the transmission channel.

In one preferred embodiment, the remote tripping device according to the invention has a number of detectors which operate in parallel, each having a total n of required repetitions, which total n is in each case set individually on the basis of the bit error rate and on the basis of a safety and/or security level which is predetermined for the respective detector. It is thus possible for different switching signals to be transmitted, with different safety and/or security requirements, in a very short time for the respective switching signal.

Further preferred embodiments can be found in the dependent patent claims.

### BRIEF DESCRIPTION OF THE DRAWINGS

The subject matter of the invention will be explained in more detail in the following text on the basis of a preferred exemplary embodiment, which is illustrated in the attached drawings, in which:

FIG. 1 shows a signal flow diagram for a remote tripping device according to the invention; and

FIG. 2 shows typical relationships between the bit error rate, the safety and/or security values and a number of correctly received codes.

The reference symbols used in the drawings and their meanings are listed in summarized form in the list of reference symbols. In principle, identical parts are provided with the same reference symbols in the figures.

### APPROACHES TO IMPLEMENTATION OF THE INVENTION

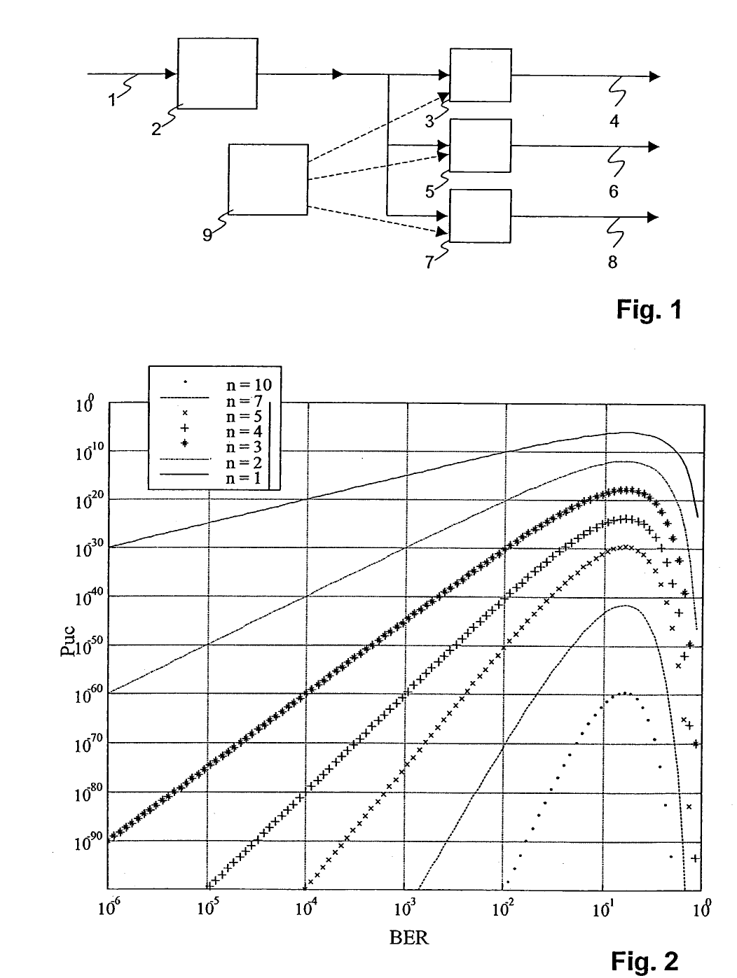

FIG. 1 shows a signal flow diagram of a remote tripping device according to the invention. A received signal input 1 leads to a receiver 2. One output of the receiver 2 leads to a number of detectors 3, 5, 7 which each have associated detector outputs 4, 6, 8. A disturbance estimator 9 is designed to transmit a measure of a disturbance of a received signal to the detectors 3, 5, 7. This transmission is represented by dashed lines.

At the received signal input 1, the receiver 2 receives signals from a transmission channel and, if necessary, produces a sequence of digital code words, for example a sequence of data frames, as the output, by suitable demodulation of these signals and using known synchronization mechanisms.

A first detector 3 with a first detector output 4, a second detector 5 with a second detector output 6, and a third detector 7 with a third detector output 8 are each designed for detection of a specific one of three protection signals. The invention can, of course, also be implemented with only one, two or with a greater number of detectors 3, 5, 7. The method of operation of a single detector will be explained in the following text. The detector determines the presence or absence of the associated protection signal in compliance with a predetermined safety and/or security value Puc. To do this, it has means for detection of a code which corresponds to this protection signal, or codes this protection signal. The detection of the code, that is to say the determination whether the code has or has not been received, is carried out on the basis of the sequence of digital code words.

In a first preferred embodiment of the invention, the code is a single bit within a data frame of the sequence. The bit corresponds to a specific protection signal. In a second preferred embodiment of the invention, the code is a code word comprising a number of bits. One code word corresponds to one specific protection signal. In both cases, the protection signal either corresponds to one, and only one, protection command, or to a combination of a number of protection commands. One protection command is, by way of example, a switching or blocking command, which is transmitted by one remote tripping device to a remote tripping device with the detection according to the invention.

The protection signal is regarded as having been received with a specific safety and/or security value Puc if the corresponding code has been received a specific total number of n times in a time window of predetermined length. Relationships between these variables can be determined by means of known methods from the detection theory. By way of example, the following text makes use of the relationship as is specified in IEC Standard 60834-1 Draft January 1997, Annex C. The invention can be carried out with any desired other codes and relationships between the relevant variables, and is not restricted to this example. In this case:

Puc=(p^{d}(1−p)^{m-d})ⁿ

where

p is the bit error rate BER,

d is a minimum Hamming distance of the code, and

m is the number of bits in the code word.

By way of example, FIG. 2 shows relationships between the bit error rate BER, the safety and/or security values Puc and a number n of correctly received codes. By way of example, if a signal is signaled as having been detected after the corresponding code has occurred after only n=2 times, a BER of 10e-6 results in a safety and/or security value Puc of 10e-60. Puc also rises as the BER rises. After passing a maximum, Puc decreases again, since the disturbances then predominate, the received signal becomes ever more random, and hence the probability of false reception of a command becomes less again. The curves were calculated for a code which codes 21 useful bits to form 31 bits with a Hamming distance of d=5.

According to the invention, the described relationships are determined in accordance with the code that is used and the necessary number n is determined from this, from an estimate of the BER at that time, this being the number n which is required to comply with the predetermined safety and/or security value Puc. By way of example, the following table can be read from FIG. 2, stating that n must have the stated value for a safety and/or security level Puc<10e-20 and a BER in the stated range.

| BER | n |
|---|---|
| <10e−4 | 1 |
| 10e−4 . . . 10e−2 | 2 |
| >10e−2 | 4 |

Analogously, for a safety and/or security level Puc<10e-40

| BER | n |
|---|---|
| <10e−4 | 2 |
| 10e−4 . . . 10e−3 | 3 |
| 10e−3 . . . 10e−2 | 4 |
| >10e−2 | 7 |

One or more such tables are stored in the detector. n is read from the tables on the basis of the measured BER and the required Puc, and this is used by the detector as the threshold for detection of the protection signal.

The process of estimating the BER at any given time is carried out repeatedly in the disturbance estimator 9 during operation of the remote tripping device, so that the number n of codes to be detected is also continuously readjusted to match the transmission characteristics at that time. This always ensures the shortest possible evaluation time, without exceeding a predetermined maximum safety and/or security value.

In a first preferred embodiment of the invention, the BER is estimated on the basis of reference sequences, which are inserted into the sequence of code words periodically by the transmitter.

In a second preferred embodiment of the invention, the estimation process is also or exclusively carried out on the basis of the decoded protection signals. In this case, known codes are used by means of which it is possible to detect the occurrence of one or more bit errors. In a digital code with a Hamming distance of d, up to (d/2)−1 bit errors can be detected by a code word if d is an even number and up to (d−1)/2 bit errors per code word can be detected if d is an odd number, provided that no bit errors have been corrected.

On the basis of bit errors detected in this way, the number of bit errors in a second time window is recorded continuously, and the BER at that time is determined from this.

In one preferred variant of the second embodiment of the invention, a code word which codes a specific protection signal is detected on the basis of requirements for the safety and/or security and reliability. A code with a specific Hamming distance d between the different code words is used in this case. According to the invention, an individual code word is detected on the basis of one of the three following options:

1. Safety and/or security optimized: The total Hamming distance is used in order to detect errors, giving a maximum safety and/or security level since (d−1) bit errors can be identified. However, the reliability of this detection process is comparatively low, since no bit errors are corrected and even a single bit error in the code word leads to the code word not being detected.

2. Reliability optimized: The total Hamming distance is used in order to correct as many errors as possible, resulting in a maximum reliability, but with the security and/or safety being less than with the first option. d/2 (if d is an even number) or (d−1)/2 (if d is an odd number) bit errors can be corrected. If there are errors which cannot be corrected, the code word is regarded as not having been detected.

3. A mixed form between these two extremes is implemented, that is to say some of the information in the bits of the Hamming distance are used for error detection and some are used for error correction. Depending on the length of the Hamming distance, various combinations are possible. The values for safety and/or security and reliability with this option are between the first two.

Depending on whether a code word is or is not regarded as having been detected, it is or is not taken into account in counting the number n of received codes in the time window. If n=1, that is to say if the reception of one, and only one, code is sufficient for detection of the protection signal, then the reliability and safety and/or security for detection of the protection signal are governed essentially by the reliability and safety and/or security of the detection of the code word corresponding to the choice of one of the three options mentioned above. It is preferably possible to set which of the three options is chosen individually for each protection signal.

By way of example, a code word with the Hamming distance d=5 is coded in the transmitter. The maximum number of correctable bit errors per frame is (d−1)/2=2. Depending on the choice of one of the three options mentioned above, the result of this is as follows:

1. Safety and/or security optimized: No bit errors are corrected, and a maximum of four bit errors can be identified.

2. Reliability optimized: A maximum of two bit errors can be identified and corrected.

3. Mixed form: A maximum of one bit error can be corrected, and a maximum of three bit errors can be identified.

The following table shows the effects of the choice of the three modes for reception of a code word with a specific number of bit errors:

| | Safety and/or | Reliability | |
|---|---|---|---|
| Bit error | security optimized | optimized | Mixed form |
| 0 | ✓ | ✓ | ✓ |
| 1 | 0 | ✓ | ✓ |
| 2 | 0 | ✓ | 0 |
| 3 | 0 | f | 0 |
| 4 | 0 | f | f |
| ≧5 | f | f | f |

where the meanings of the abbreviations are as follows:
✓ the code word is detected correctly
0 no code word is detected
f a false code word is detected

The elements of the remote tripping device which produce the signal flow as shown in FIG. 1 are preferably formed by an appropriately programmed data processing unit or application-specific integrated circuits (ASICs, FPGAs). However, they can also be implemented in the form of analog components and/or as a combination of discrete logic elements and/or programmed circuits. In one preferred embodiment of the invention, the detectors 3, 5, 7 and/or the disturbance estimator 9 are/is implemented in the form of an appropriately programmed digital signal processor.

A computer program for reception of digitally coded protection signals in a remote tripping device according to the invention can be loaded in an internal memory of a digital data processing unit and has computer program code means which, if they are in the form of a digital data processing unit, cause this digital data processing unit to carry out the method according to the invention. In one preferred embodiment of the invention, a computer program product has a computer-legible medium in which the computer program code means are stored.

List of reference symbols

1 Received signal input

2 Receiver

3 First detector

4 First detector output

5 Second detector

6 Second detector output

7 Third detector

8 Third detector output

9 Disturbance estimator

1. A method for reception of digitally coded protection signals in a remote tripping device for distance protection in electrical systems, in which a sequence of digital code words is received on a transmission channel, and a protection signal is regarded as having been received when a code which corresponds to this protection signal has been detected in this sequence a total of n times within a time window of predetermined length, characterized
in that the number n is determined on the basis of an estimate of a measure at any given time of a disturbance on the transmission channel.

2. The method as claimed in claim 1, characterized in that the measure of the disturbance on the transmission channel is a bit error rate on the transmission channel, and the number n is determined on the basis of the bit error rate and a requirement for the safety and/or security level of the transmission.

3. The method as claimed in claim 2, characterized in that the bit error rate is determined on the basis of the received sequence of code words.

4. The method as claimed in claim 1, characterized in that a number of protection signals are detected simultaneously on the basis of a number of codes, with an associated dedicated safety and/or security level being predetermined for each protection signal.

5. The method as claimed in claim 1, characterized in that the code is a code word comprising a number of bits, and in that the code word is detected on the basis of the protection signal with optimum safety and/or security or with optimum reliability, or on the basis of a mixed form.

6. A remote tripping device for distance protection in electrical systems, having a means (2) for reception of a sequence of digital code words on a transmission channel, at least one detector (3, 5, 7) for detection of a code which corresponds to a protection signal, and at least one means for signaling that a protection signal is regarded as having been received if a code which corresponds to the protection signal is detected a total of n times in this sequence within a time window of predetermined length, characterized
in that the number n can be determined on the basis of an estimate of a measure at any given time of a disturbance on the transmission channel.

7. The remote tripping device as claimed in claim 6, characterized in that the remote tripping device has a number of detectors (3, 5, 7) which operate in parallel, in which the number n of required repetitions can in each case be set individually on the basis of the measure for the disturbance and on the basis of a safety and/or security level which is predetermined for the respective detector (3, 5, 7).
